(19) United States
(12) Patent Application Publication
(10) Pub. No.: US 2025/0111604 A1
(43) Pub. Date: Apr. 3, 2025

(54) OPTIMIZING LEVEL OF DETAIL GENERATION IN VIRTUAL ENVIRONMENTS

(71) Applicant: Meta Platforms Technologies, LLC, Menlo Park, CA (US)

(72) Inventors: Moran Vatelmacher, Hod Hasharon (IL); Eran Guendelman, Tel Aviv (IL); Maxim Bluvshtein, Herzliya (IL); Berta Bescós Torcal, Gattikon (CH)

(21) Appl. No.: 18/478,885

(22) Filed: Sep. 29, 2023

(51) Int. Cl. G06T 17/00; G06V 10/25; G06V 10/44; G06V 10/74

(52) U.S. Cl. CPC G06T 17/00; G06V 10/25; G06V 10/44; G06V 10/761

(57) ABSTRACT

A method and system for generating versions of assets comprising various levels of detail is provided. The method includes receiving, at a client device, a first input representation of an asset at a lowest level of detail and a second input representation of an asset at a highest level of detail. The method further includes analyzing the first model input and the second model input and identifying a set of parameters based thereon. The method further includes generating a plurality of models representing the asset with different intermediate levels of detail based on the set of parameters, displaying, at the client device, a model from the plurality of models based on a proximity of the asset from a viewpoint of the user in a virtual environment.

### BACKGROUND

### Field

The present disclosure is generally related to automating level of detail in asset generation. More specifically, the present disclosure includes leveraging a combination of manual control and interpolation techniques to achieve optimal performance while maintaining the visual integrity of assets in virtual environments.

### Related Art

In virtual environments, the representation of avatars and avatar apparel plays a crucial role in providing a realistic and immersive experience. An asset's level of detail can greatly affect the quality of the immersive experience and run time performance. Some assets may be customized or created by users. Users may be required to create multiple versions of the same asset to account for different resolutions/number of vertices for differing use cases. The complexity and high-polygon nature of detailed models can be computationally expensive, leading to performance issues. As such, there is a need to provide users with asset, e.g., version generation that aims to improve visual quality and computational efficiency.

### SUMMARY

The subject disclosure provides for systems and methods for level of detail generation for assets. In one aspect of the present disclosure, the method includes receiving a first model input and a second model input, at a client device, wherein the first model input is a representation of an asset at a lowest level of detail and the second model input is a representation of the asset at a highest level of detail, analyzing the first model input and the second model input, identifying a set of parameters based on the analyzing, generating a plurality of models representing the asset with intermediate levels of detail based on the set of parameters, and displaying, at the client device, a model from the plurality of models based on a proximity of the asset from a viewpoint of a user in a virtual environment.

Another aspect of the present disclosure relates to a system configured for level of detail generation for assets. The system includes one or more processors, and a memory storing instructions which, when executed by the one or more processors, cause the system to perform operations. The operations include receiving a first model input and a second model input, at a client device, wherein the first model input is a representation of an asset at a lowest level of detail and the second model input is a representation of the asset at a highest level of detail, analyzing the first model input and the second model input, identifying a set of parameters based on the analyzing, generating a plurality of models representing the asset with intermediate levels of detail based on the set of parameters, wherein each of the plurality of models comprises a different level of detail, and displaying, at the client device, a model from the plurality of models based on a proximity of the asset from a viewpoint of a user in a virtual environment.

Another aspect of the present disclosure relates to a method including receiving a first model input and a second model input, at a client device, wherein the first model input is a representation of an asset at a lowest level of detail and the second model input is a representation of the asset at a highest level of detail, analyzing the first model input and the second model input, identifying a set of parameters based on the analyzing, interpolating between the first model input and the second model input to generate a plurality of models representing the asset with intermediate levels of detail based on the set of parameters, wherein each of the plurality of models comprises a different level of detail, and displaying, at the client device, a model from the plurality of models based on a proximity of the asset from a viewpoint of a user in a virtual environment.

Yet another aspect of the present disclosure relates to a non-transient computer-readable storage medium having instructions embodied thereon, the instructions being executable by one or more processors to perform one or more of the methods according to one or more embodiments described herein.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 illustrates a network architecture used to implement a feature to keep selected messages in a network chat, according to some embodiments.

FIG. 2 is a block diagram illustrating details of devices used in the architecture of FIG. 1, according to some embodiments.

FIG. 3 illustrates a block diagram including computing platforms configured to level of detail generation in a virtual environment, according to one or more embodiments.

FIG. 4 illustrates a flowchart of a method for level of detail generation in a virtual environment, according to some embodiments.

FIG. 5 is an exemplary illustration of input models and corresponding intermediate levels of detail generated for an asset, according to some embodiments.

FIG. 6 is a block diagram illustrating a computer system used to at least partially carry out one or more of operations in methods disclosed herein, according to some embodiments.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

In virtual environments, the representation of assets/models play a crucial role in providing a realistic and immersive experience. An asset's (e.g., avatars, avatar apparel, features, etc.) level of detail can greatly affect the quality of the immersive experience and run time performance. The complexity and high-polygon nature of detailed models can be computationally expensive, leading to performance issues. These issues are especially pertinent in resource-constrained systems such as, but not limited to, virtual reality (VR) headsets and/or other augmented reality (AR) and mixed reality (MR) systems. Some assets may be customized or created by users. In order to account for different use cases including different resolutions/number of vertices, users may create multiple versions of the same asset, each containing different levels of details. Various LODs of the same model may be required, for example, to adjust between instances when the object is closer to a viewpoint (i.e., the object appears closer to the user in the virtual environment) and when the object moves further away from the viewpoint. At closer proximity, the LOD of the asset may be reduced without a quality of the object changing to the human eye. By displaying lower LOD when the object is further away, the system utilizes less compute resources, and thus saves cost. Although manual creation of the multiple versions allows for increased user control over where to save/allocate more resources for details (e.g., at the neckline of an avatar) and where reduced detailing with low amounts of vertices (e.g., smooth areas) would suffice, the process is inefficient and requires increased overall creation time, processing time, speed, and resources.

To address the aforementioned challenges, embodiments of this disclosure describe automatic level of detail (LOD) generation by combining manual creation of the lowest-resolution LOD representation of an asset with automatic interpolation between the highest and lowest resolution LODs. Embodiments describe methods and systems that improve computational efficiency while maintaining visual quality by automating LOD generation while being able to easily get artistic inputs from a user on areas to preserve (e.g., focus points for increased LOD).

According to embodiments, the automated LOD generation interpolates different LOD levels from user inputs (e.g., examples of an asset), rather than extrapolating the different LOD levels from a single example, so as to preserve artistic intent. In some implementations, the user inputs comprise two inputs including a highest-resolution LOD and a lowest-resolution LOD. The two examples or variations of the asset implicitly show areas of the asset where the user wants to preserve details. Automating the LOD generation in this way allows for generation of endless versions (e.g., comprising different LOD) for an input asset.

Embodiments, as disclosed herein, provide a solution rooted in computer technology and arising in the realm of computer networks, namely generating levels of detail in assets for objects in a virtual environment by leveraging manual control and an interpolation model. The disclosed subject technology facilitates an effective solution to balance visual quality and computational efficiency and improving the technological field of asset generation as well as user experience and the development process, making it more efficient and accessible for content creators and consumers alike.

### Example Architecture

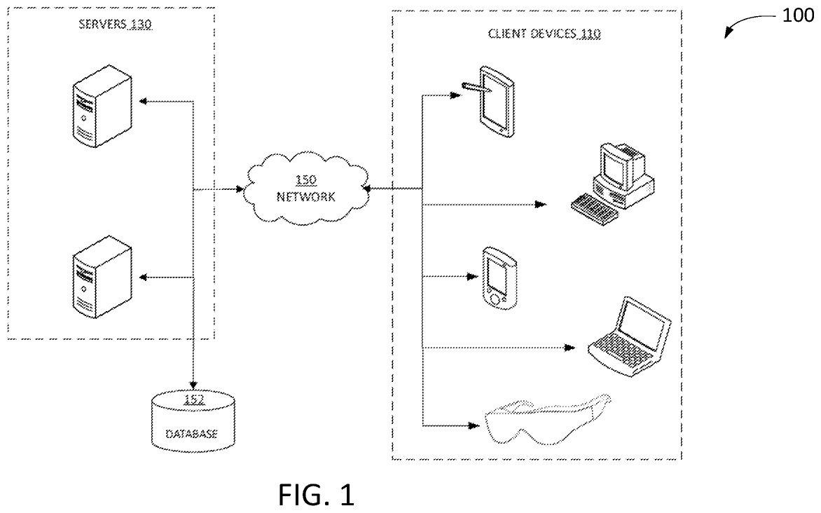

FIG. 1 illustrates a network architecture 100 in which methods, apparatuses, and systems described herein may be implemented. Architecture 100 may include servers 130 and a database 152, communicatively coupled with multiple client devices 110 via a network 150. Any one of servers 130 may host a social media platform running on client devices 110, used by one or more of the participants in the network. The servers 130 may include a cloud server or a group of cloud servers. In some implementations, the servers 130 may not be cloud-based (i.e., may be implemented outside of a cloud computing environment) or may be partially cloud-based. Client devices 110 may include any one of a laptop computer, a desktop computer, or a mobile device such as a smart phone, a palm device, or a tablet device. In some embodiments, client devices 110 may include a headset or other wearable device (e.g., a virtual reality or augmented reality headset or smart glass), such that at least one participant may be running an immersive reality social media application installed therein. The database 152 may store backup files from the LOD corresponding to, e.g., highest and lowest LOD representations, metadata associated with LODs, such as values or tags indicating resolution/number of vertices.

Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like, and/or a combination of these or other types of networks.

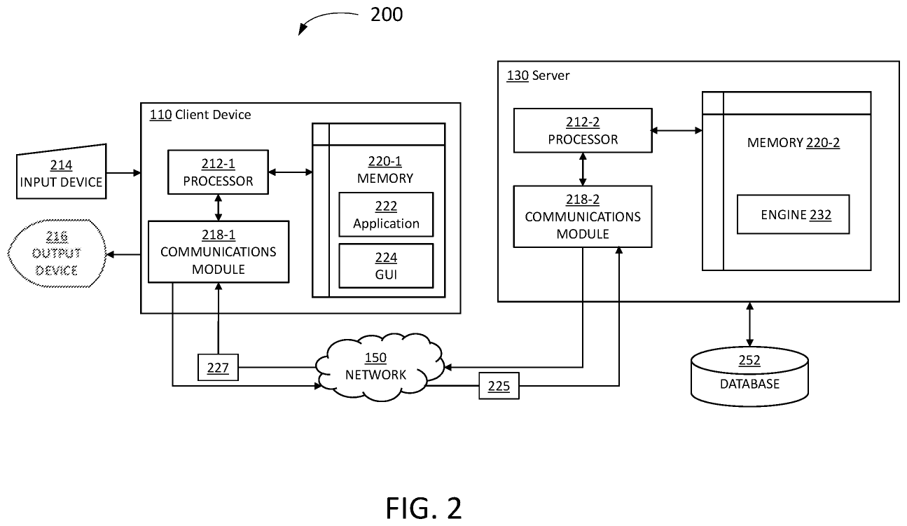

FIG. 2 is a block diagram 200 illustrating details of a client device 110 and a server 130 used in a network architecture as disclosed herein (e.g., architecture 100), according to some embodiments. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as requests, responses, messages, and commands to other devices on the network 150 in the form of datasets 225 and 227. Communications modules 218 can be, for example, modems or Ethernet cards, and may include radio hardware and software for wireless communications (e.g., via electromagnetic radiation, such as radiofrequency-RF-, near field communications-NFC-, Wi-Fi, and Bluetooth radio technology). Client device 110 may be coupled with an input device 214 and with an output device 216. Input device 214 may include a mouse, a keyboard, a pointer, a touchscreen, a microphone, a joystick, a virtual joystick, a touch-screen display that a user may use to interact with client device 110, or the like. In some embodiments, input device 214 may include cameras, microphones, and sensors, such as touch sensors, acoustic sensors, inertial motion units-IMUs- and other sensors configured to provide input data to a VR/AR headset. Likewise, output device 216 may include a display and a speaker with which the consumer may retrieve results from client device 110.

Client device 110 may also include a processor 212-1, configured to execute instructions stored in a memory 220-1, and to cause client device 110 to perform at least some of the steps in methods consistent with the present disclosure. Memory 220-1 may further include an application 222 (e.g., VR application) and a GUI 224, configured to run in client device 110 and couple with input device 214 and output device 216. The application 222 may include one or more modules configured to perform operations according to aspects of embodiments. The application 222 may include specific instructions which, when executed by processor 212-1, cause operations to be performed according to methods described herein. For example, the instructions may cause the processor to display a dataset 227 from server 130 for the consumer via GUI 224. In some embodiments, the application 222 runs on any operating system (OS) installed in client device 110. In some embodiments, the application 222 may be downloaded by the user from the server 130 and may be hosted by the server 130. In some embodiments, the processor is configured to control a graphical user interface (GUI) for the user of one of client devices 110 accessing the server of the social platform.

Dataset 227 may include multiple LOD files (i.e., assets with different LODs) provided by one or more instances of the application. A participant (e.g., artist/creator) using client device 110 may store at least some of the data content in dataset 227 in memory 220-1. In some embodiments, a participant may upload, with client device 110, a dataset 225 onto server 130, as part of an input. Accordingly, dataset 225 may include an input asset comprising a first LOD. The input asset may be in the form of a media file, image, or other data file.

A database 252 may store data and files associated with data of LODs, asset information, virtual world information, etc., from the application 222 (e.g., one or more of datasets 227 and 225).

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. Memory 220-2 stores instructions which, when executed by a processor 212-2, causes server 130 to perform at least partially one or more operations in methods consistent with the present disclosure. In some embodiments, memory 220-2 includes an engine 232. The engine 232 may include computing platform(s) and share or provide features and resources to GUI 225, including multiple tools associated with image or video collection, capture, or design applications that use images or pictures retrieved with engine 232 (e.g., application 222). The engine 232 may include one or more modules configured to perform operations according to aspects of embodiments (e.g., performing automatic LOD generation according to embodiments). The user may access engine 232 through application 222, installed in a memory 220-1 of client device 110. Accordingly, application 222, including GUI 225, may be installed by server 130 and perform scripts and other routines provided by server 130 through any one of multiple tools. Execution of application 222 may be controlled by processor 212-1.

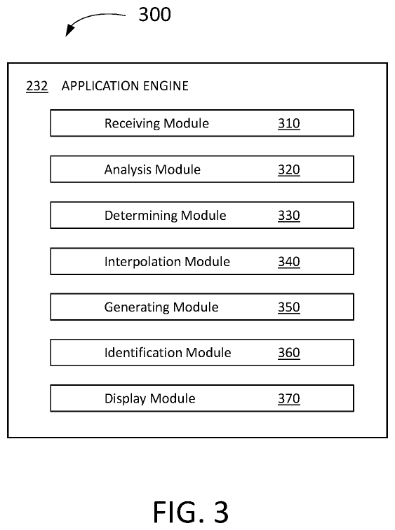

Engine 232 may include one or more modules (e.g., modules later described with reference to system 300 in FIG. 3) configured to perform operations according to one or more aspects of embodiments described herein. The engine 232 may include a neural network tool which may be part of one or more machine learning models stored in the database 252. The database 252 includes training archives and other data files that may be used by engine 232 in the training of a machine learning model, according to the input of the user through application 222. Moreover, in some embodiments, at least one or more training archives or machine learning models may be stored in either one of memories 220 and the user may have access to them through application 222. The neural network tool may include algorithms trained for the specific purposes of the engines and tools included therein. The algorithms may include machine learning or artificial intelligence algorithms making use of any linear or non-linear algorithm, such as a neural network algorithm, or multivariate regression algorithm. In some embodiments, the machine learning model may include a neural network (NN), a convolutional neural network (CNN), a generative adversarial neural network (GAN), a deep reinforcement learning (DRL) algorithm, a deep recurrent neural network (DRNN), a classic machine learning algorithm such as random forest, k-nearest neighbor (KNN) algorithm, k-means clustering algorithms, or any combination thereof. More generally, the machine learning model may include any machine learning model involving a training step and an optimization step. In some embodiments, the database 252 may include a training archive to modify coefficients according to a desired outcome of the machine learning model. Accordingly, in some embodiments, engine 232 is configured to access database 252 to retrieve documents and archives as inputs for the machine learning model. In some embodiments, engine 232, the tools contained therein, and at least part of database 252 may be hosted in a different server that is accessible by server 130 or client device 110.

FIG. 3 illustrates an example block diagram including computing platforms of the engine 232 configured to perform LOD generation, according to one or more embodiments. The computing platform(s) may be configured by machine-readable instructions. Machine-readable instructions may include one or more instruction modules. The instruction modules may include computer program modules. As shown in FIG. 3, the instruction modules may include one or more of a receiving module 310, analysis module 320, determining module 330, interpolation module 340, generating module 350, identification module 360, display module 370, and/or other instruction modules.

In some implementations, one or more of the modules 310, 320, 330, 340, 350, 360, and 370 may be included in the client device 110 (e.g., in the application 222) and performed by one or more processors (e.g., processor 212-1). In some implementations, one or more of the modules 310, 320, 330, 340, 350, 360, and 370 may be included in the server 130 (e.g., in the engine 232) and performed by one or more processors (e.g., processor 212-2). In some implementations, one or more of the modules 310, 320, 330, 340, 350, 360, and 370 are included in and performed by a combination of the client device and the server.

The receiving module 310 may be configured to receive first input of an asset at a first LOD. The asset may be a model or object such as an avatar in a virtual environment, media content item, digital content, etc. In some implementations, the asset is a feature of the model or object (e.g., avatar apparel, garment, facial features, textures, or the like). The asset in the first LOD may be created by a user (e.g., creator, developer, or the like) of a VR application to be used in the virtual environment. In some implementations, the first LOD is a lowest-resolution LOD for the asset. Creating the lowest-resolution LOD may entail simplifying a model representation of the asset by reducing a polygon count of the asset while retaining a set of key features which may include essential features of the asset (e.g., shape, visual appearance, size, orientation, etc.). The user may manually control the LOD creation of the lowest-resolution LOD. This ensures that the lowest-resolution model representation maintains the overall design integrity and preserves the key features of the asset.

The receiving module 310 may be further configured to receive second input of an asset at a second LOD. In some implementations, the second LOD is a highest-resolution LOD for the asset.

The analysis module 320 may be configured to analyze the first input to identify parameters of the first LOD. The parameters may include a corresponding value, as such the parameters may be name-value pairs. The analysis module 320 may be further configured to analyze the second input to identify parameters of the second LOD. Parameters may include, but are not limited to, polygon count, resolution value(s), number of vertices, distance of the asset from a user's viewpoint, height and dimensions of the asset.

According to some embodiments, system 300 may be further configured to extract the parameters identified in the first and second LODs. The parameters may be stored in a database/data storage associated with, e.g., the virtual environment or the like.

In some implementations, system 300 may be further configured to identify areas of importance based on the analysis of the analysis module 320 and the parameters identified therefrom. The areas of importance indicate aspects (i.e., areas) of the asset that should be preserved. Similarly, the areas of importance may indicate aspects of the asset wherein the LOD does not need to be preserved (e.g., the LOD may be reduced) based on the user's design constraints derived from the first and second inputs.

The determining module 330 may be configured to determine intermediate (model) LODs for the asset based on the parameters associated with the first LOD and the second LOD. That is, based on the two endpoints for the LODs of the asset (signified by the first LOD and the second LOD), a plurality of intermediate LODs between the two endpoints are determined to ensure a smooth transition between the LODs. By determining the intermediate LODs based on user's input, the system 300 is able to preserve consistency and visual integrity of the essential design elements across all LODs. A number of intermediate LODs included in the plurality of intermediate LODs may be determined based on, for example, the platform (e.g., VR, MR, AR), bandwidth of client device, and a complexity of the model (e.g., an avatar calls for more detail than another object such as a box). As such, system 300 is scalable and accessible, as it can adapt to a wide range of hardware configurations and performance capabilities. This ensures accessibility to a broader audience, including users with lower-end devices.

According to some embodiments, system 300 may be further configured to identify features of the asset from at least one of the first or second inputs and assign weights to each of the features (e.g., facial features of an asset, hands/fingers, or other regions of the asset, garments, etc.) based on an LOD of the feature. For example, a feature with area of importance may be assigned a higher weight so as to limit the change in detail between intermediate LODs. As another example, an area with low importance may be assigned a lower weight which would allow for an increase in the modifications (e.g., reduction in the level of detail) made to the area in each of the intermediate LODs. The intermediate LODs may be determined by interpolating between the first and second inputs based on the parameters and their weights.

The interpolation module 340 is configured to perform a process of interpolation to generate the intermediate LODs between the lowest and highest LODs (or resolutions). Embodiments are not limited to this configuration. In some embodiments, the interpolation module 340 is included in the determining module 330. By non-limiting example, the process of interpolation may include, based on the analysis (by the analysis module 320) of the second input, extrapolating missing details between the first and second LODs and automatically interpolating the LODs to generate a smooth transition between the different levels of detail. This provides a seamless visual transition between the first and second LODs as, for example, the viewpoint, distance of the asset, or system resources change. The automatic interpolation further guarantees a seamless visual experience as users transition between the intermediate LODs. Additionally, with the manual creation of the lowest/highest resolution LOD and the automated interpolation, users can streamline the LOD generation process and reduce creation time. This approach minimizes the time and effort required for creating multiple LODs manually.

In some implementations, the process of interpolation may be performed using a machine learning (ML) model trained on data including, but not limited to, LOD in other objects in the virtual environment, previously input reference assets (i.e., historical data), related assets created by the user and/or other users of the virtual applications associated with the user or otherwise, etc.

In some implementations, the system 300 may include determining a category or type of the input asset, and further tracking a trend in the intermediate LODs based on the asset category/type. By non-limiting example, the asset may fall into the category of avatars, garments, furniture, etc. The category may even be narrowed to comprise tops, bottoms, shoes, etc. Once the category/type of the input asset is determined, trends or patterns of similarity may be identified between assets of the same category/type and stored in a database, or the like. The system 300 (e.g., the determining module 330) may be further configured to make assumptions based on the category/type, identified trends, and/or patterns when, for example, generating intermediate LODs and/or identifying (relevant) parameters.

The generating module 350 may be configured to generate a first reference mesh of the asset at the first LOD and a second reference mesh of the asset at the second LOD (e.g., a reference mesh representing the lowest and highest resolutions/LOD).

According to some embodiments, the system 300 may further include determining a weight (or cost value) of each of the parameters (e.g., vertices and geometry) identified in the first and second reference mesh based on a difference between the LODs. Each parameter may be associated with one or more weights (e.g., edges of a tringle comprised in the asset may correspond to different weights). The weights indicate a level of which removal or reduction of the parameter will affect the visual representation of the asset. In some implementations, the number of intermediate LODs included in the plurality of intermediate LODs may be determined based on the difference between the LODs. A sum of the cost for each of the intermediate LODs (e.g., a max weight of an intermediate LOD representation of the asset) may be calculated based on the number of intermediate LODs and the weights of each of the parameters. Each intermediate LOD may be generated based on the sum of the cost and the first and second reference mesh.

The identification module 360 may be configured to continuously identify a proximity of the asset based on the viewpoint of the user and select an intermediate LOD (e.g., from the plurality of intermediate LODs) based on the proximity. For example, an intermediate LOD with a higher resolution may be selected when the proximity is lower (i.e., the asset is closer in the virtual environment). Similarly, for example, an intermediate LOD with a lower resolution may be selected when the proximity is higher (i.e., the asset is further away in the virtual environment).

In some implementations, the intermediate LOD is selected based on compute resources necessary to display the asset to the user at a given viewpoint. By dynamically adapting the LOD based on the user's proximity to the avatar (i.e., viewpoint) or the available computational resources, performance of the system 300 can be significantly improved without sacrificing visual quality.

The display module 370 may be configured to display the intermediate LODs to the user at a client device in the virtual environment. In an instance of the application, for example, at a given proximity, the display module 370 may display the selected intermediate LODs. A display of the various intermediate LODs may be performed consecutively in an order (e.g., ascending or descending) based on a direction of movement of the asset so as to ensure that the transition is undetectable to the user.

The description of the functionality provided by the different modules 310, 320, 330, 340, 350, 360, and 370 described below is for illustrative purposes, and is not intended to be limiting, as any of modules 310, 320, 330, 340, 350, 360, and/or 370 may provide more or less functionality than is described. For example, one or more of modules 310, 320, 330, 340, 350, 360, and/or 370 may be eliminated, and some or all of its functionality may be provided by other ones of modules 310, 320, 330, 340, 350, 360, and/or 370. As another example, processor(s) 212 may be configured to execute one or more additional modules that may perform some or all of the functionality attributed below to one of modules 310, 320, 330, 340, 350, 360, and/or 370.

Although FIG. 3 shows example blocks of the system 300, in some implementations, the system 300 may include additional blocks, fewer blocks, different blocks, or differently arranged blocks than those depicted in FIG. 3. Additionally, or alternatively, two or more of the blocks of the system may be combined.

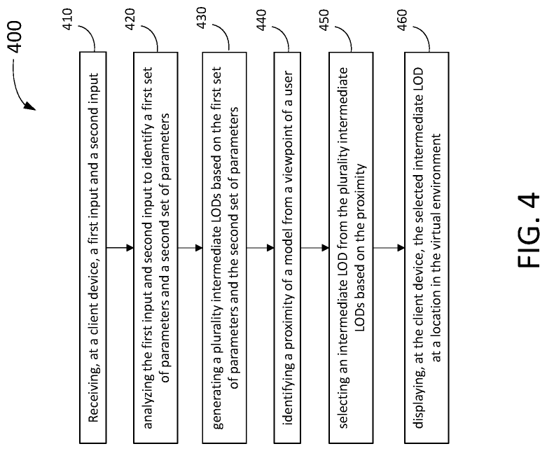

FIG. 4 illustrates an example flow diagram of a method 400 for LOD generation, according to some embodiments. For explanatory purposes, the operations of the example method 400 are described herein as occurring in serial, or linearly. However, multiple instances of the example method 400 may occur in parallel.

In operation 410, the method 400 includes receiving a first input and a second input. The first input may be a model or representation of an asset at a lowest-resolution LOD. The second input may be a model or representation of an asset at a highest-resolution LOD. The asset may be, for example, an avatar or other media content item in a virtual environment. The first and second inputs are received at a client device of a user (e.g., creator, developer, or the like) and may comprise models created and/or modified by the user.

In operation 420, the method 400 includes analyzing the first input and second input to identify a first set of parameters and a second set of parameters of the model, respectively. Parameters may include, but are not limited to, polygon count, resolution, number of vertices, distance of the model from a user's viewpoint in the virtual environment, height and dimensions of the model, or the like.

According to some embodiments, the method 400 includes extracting the first set of parameters and the second set of parameters and storing the data in a database. The stored data may be used as training data to train one or more ML models, according to one or more embodiments.

According to some embodiments, the method 400 includes identifying areas of importance based on an analysis of at least one of the first and second inputs. In some implementations, the area of importance may be a region of the model that should be preserved based on a comparison of the first and second inputs. For example, the user creates a model of an avatar with a high level of detail/resolution in the facial region of the avatar in both the first and second inputs. As such, based on an analysis of the model (e.g., at operation 420), the facial region may be identified as an area of importance. Thus, details in the facial region may be preserved (and/or minimally reduced) in any system or auto-generated version of the model.

In some implementations, the method 400 may include identifying an area of minimal importance. For example, the user may create a model of an avatar with the first and second inputs containing minor detailing in a lower body region of the avatar. As such, details of the lower body region may be increasingly reduced in any system or auto-generated version of the model.

In operation 430, the method 400 includes generating a plurality of intermediate LODs of the model based on the first set of parameters and the second set of parameters. The plurality of intermediate LODs are representations of the model with resolutions between the LODs of the first and second inputs. Each of the plurality of intermediate LODs may correspond to different levels of detail. According to embodiments, determining the plurality of intermediate LODs may include interpolating between the first and second inputs based on the first and second set of parameters. In some embodiments, the interpolation is performed using an ML model.

According to some embodiments, the method 400 may further include generating the plurality of intermediate LODs with the area of importance preserved in its level of detail.

According to some embodiments, the method 400 may further include generating reference mesh of the model based on the first and second inputs and applying the intermediate LOD to the reference mesh.

In operation 440, the method 400 includes identifying a proximity of the model from a viewpoint of the user. The proximity may also be defined as the distance of the model from the user within the virtual environment or a position of the model in the virtual environment. Operation 440 may be performed continuously or at predetermined time intervals so as to provide real-time updates to a system performing the method 400.

In operation 450, the method 400 includes selecting an intermediate LOD from the plurality of intermediate LODs of the model based on the identified proximity.

In operation 460, the method 400 includes displaying, at the client device, the selected intermediate LOD at a location in the virtual environment corresponding to the proximity.

In some implementations, a second intermediate LOD with lower LOD/resolution than the selected intermediate LOD may be displayed based on compute resources at the client device fails to reach a threshold value.

Although FIG. 4 shows example blocks of the methods 400, in some implementations, the methods 400 may include additional blocks, fewer blocks, different blocks, or differently arranged blocks than those depicted in FIG. 4. Additionally, or alternatively, two or more of the blocks of the method may be performed in parallel.

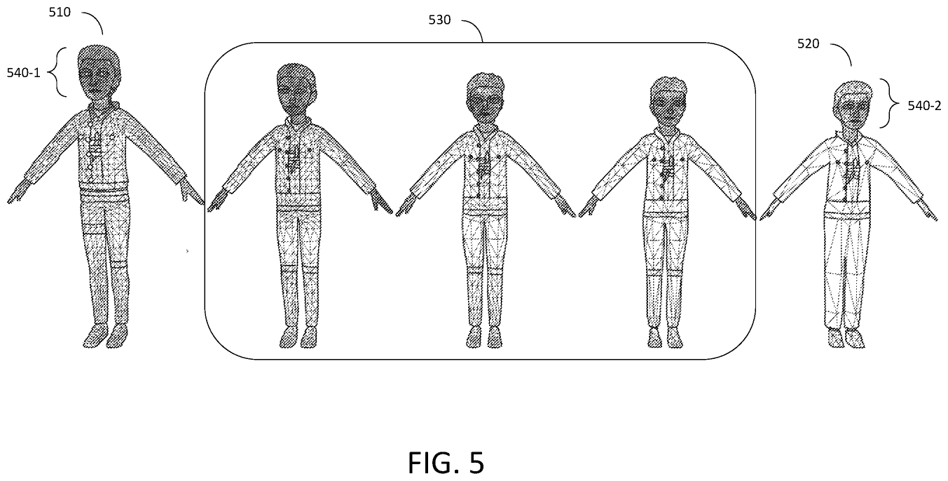

FIG. 5 is an exemplary illustration of input models and corresponding intermediate LODs generated, according to one or more embodiments. As shown in FIG. 5, the asset is an avatar. First input 510 may correspond to a highest-resolution LOD model or representation of the avatar. Second input 520 may correspond to a lowest-resolution LOD model or representation of the avatar. A user may generate the first and second inputs 510/520 as input to a system/method (e.g., system 300/method 400), according to embodiments. Intermediate LODs 530 are LODs of the asset generated based on the inputs.

An analysis of the first and second inputs 510/520 may identify that the facial regions 540-1/540-2 (generally referenced as facial region 540) constitute an area of importance. As such, a level of detail in the facial regions of the intermediate LODs may be preserved (i.e., not reduced significantly).

LOD generation for models/assets (e.g., avatar or avatar apparel) through the manual creation of the lowest-resolution LOD and automatic interpolation between the highest-resolution LOD and the lowest-resolution LOD presents an effective solution to balance visual quality and computational efficiency. By leveraging a combination of manual control and automated techniques, embodiments can achieve optimal performance while maintaining the visual integrity of models/assets. This approach not only improves the user experience but also streamlines the development process, making it more efficient and accessible for content creators and consumers alike.

### Hardware Overview

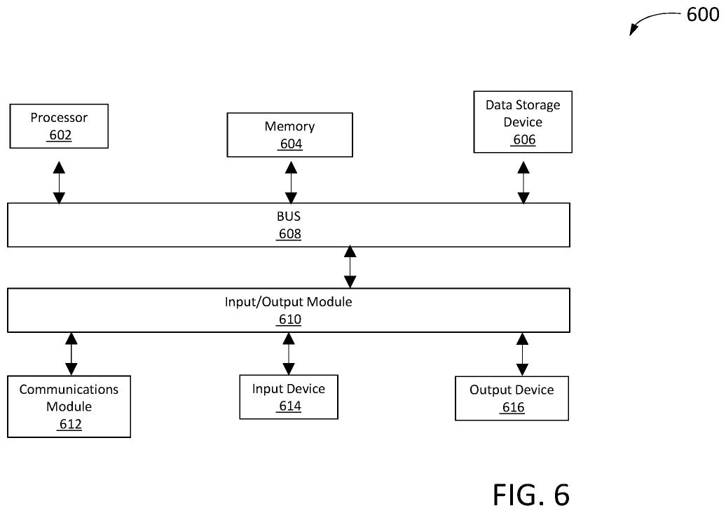

FIG. 6 is a block diagram illustrating an exemplary computer system 600 with which the client and server of FIGS. 1 and 2, and method 400 can be implemented. In certain aspects, the computer system 600 may be implemented using hardware or a combination of software and hardware, either in a dedicated server, or integrated into another entity, or distributed across multiple entities. Computer system 600 may include a desktop computer, a laptop computer, a tablet, a phablet, a smartphone, a feature phone, a server computer, or otherwise. A server computer may be located remotely in a data center or be stored locally.

Computer system 600 (e.g., client 110 and server 130) includes a bus 608 or other communication mechanism for communicating information, and a processor 602 (e.g., processors 212) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memories 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java,.NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. Input/output module 610 can be any input/output module. Exemplary input/output modules 610 include data ports such as USB ports. The input/output module 610 is configured to connect to a communications module 612. Exemplary communications modules 612 (e.g., communications modules 218) include networking interface cards, such as Ethernet cards and modems. In certain aspects, input/output module 610 is configured to connect to a plurality of devices, such as an input device 614 (e.g., input device 214) and/or an output device 616 (e.g., output device 216). Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 616 include display devices, such as an LCD (liquid crystal display) monitor, for displaying information to the user.

According to one aspect of the present disclosure, the client device 110 and server 130 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, performed by at least one processor, the method comprising:
receiving a first model input and a second model input, at a client device, wherein the first model input is a representation of an asset at a lowest level of detail and the second model input is a representation of the asset at a highest level of detail;
analyzing the first model input and the second model input;
identifying a set of parameters based on the analyzing;
generating a plurality of models representing the asset with intermediate levels of detail based on the set of parameters; and
displaying, at the client device, a model from the plurality of models based on a proximity of the asset from a viewpoint of a user in a virtual environment.

2. The computer-implemented method of claim 1, wherein each of the plurality of models comprises a different level of detail.

3. The computer-implemented method of claim 1, wherein the generating includes interpolating between the first model input and the second model input.

4. The computer-implemented method of claim 1, further comprising:
determining the proximity of the asset from the viewpoint of the user in the virtual environment; and
selecting at least one of the plurality of models based on the proximity.

5. The computer-implemented method of claim 1, wherein the plurality of models are displayed in an order with descending or ascending level of detail based on a direction of movement of the asset in the virtual environment.

6. The computer-implemented method of claim 1, further comprising:
determining an area of importance for the asset based on the first model input, the second model input, and the set of parameters; and
generating the plurality of models with the area of importance preserved in level of detail.

7. The computer-implemented method of claim 1, further comprising:
identifying features of the asset from at least one of the first model input and the second model input; and
assigning a weight to each of the features based on a level of detail associated with each of the features, wherein the plurality of models are generated based on weights of the features.

8. The computer-implemented method of claim 1, wherein the asset is at least one of an avatar or an apparel of the avatar.

9. The computer-implemented method of claim 1, wherein the set of parameters include a first set of parameters from the first model input and a second set of parameters from the second model input, parameters in the first set of parameters and the second set of parameters including at least a polygon count, resolution value, and number of vertices identified in the first model input and the second model input.

10. The computer-implemented method of claim 1, further comprising:
determining a number of intermediate models for the asset given the first model input and the second model input based on a complexity of the asset and a platform of the virtual environment; and
generating the plurality of models based on the number of intermediate models, a number of models included in the plurality of models corresponding to the number of intermediate models.

11. A system for level of detail generation, the system comprising:
one or more processors; and
a memory storing instructions which, when executed by the one or more processors, cause the system to:
receive a first model input and a second model input, at a client device, wherein the first model input is a representation of an asset at a lowest level of detail and the second model input is a representation of the asset at a highest level of detail;
analyze the first model input and the second model input;
identify a set of parameters based on the analyzing;
generate a plurality of models representing the asset with intermediate levels of detail based on the set of parameters, wherein each of the plurality of models comprises a different level of detail; and
display, at the client device, a model from the plurality of models based on a proximity of the asset from a viewpoint of a user in a virtual environment.

12. The system of claim 11, wherein the one or more processors further execute instructions to:
interpolate between the first model input and the second model input to generate the plurality of models.

13. The system of claim 11, wherein the one or more processors further execute instructions to:
determine the proximity of the asset from the viewpoint of the user in the virtual environment; and
select at least one of the plurality of models based on the proximity.

14. The system of claim 11, wherein the one or more processors further execute instructions to:
determine an area of importance for the asset based on the first model input, the second model input, and the set of parameters; and
generate the plurality of models with the area of importance preserved in level of detail.

15. The system of claim 11, wherein the one or more processors further execute instructions to:
identify features of the asset from at least one of the first model input and the second model input; and
assign a weight to each of the features based on a level of detail associated with each of the features, wherein the plurality of models are generated based on weights of the features.

16. The system of claim 11, wherein the asset is at least one of an avatar or an apparel of the avatar.

17. The system of claim 11, wherein the set of parameters include a first set of parameters from the first model input and a second set of parameters from the second model input, parameters in the first set of parameters and the second set of parameters including at least a polygon count, resolution value, and number of vertices identified in the first model input and the second model input.

18. The system of claim 11, wherein the one or more processors further execute instructions to:
determine a number of intermediate models for the asset given the first model input and the second model input based on a complexity of the asset and a platform of the virtual environment; and
generate the plurality of models based on the number of intermediate models, a number of models included in the plurality of models corresponding to the number of intermediate models.

19. A non-transient computer-readable storage medium having instructions embodied thereon, the instructions being executable by one or more processors to perform a method and cause the one or more processors to:
receive a first model input and a second model input, at a client device, wherein the first model input is a representation of an asset at a lowest level of detail and the second model input is a representation of the asset at a highest level of detail;
analyze the first model input and the second model input;
identify a set of parameters based on the analyzing;
interpolate between the first model input and the second model input to generate a plurality of models representing the asset with intermediate levels of detail based on the set of parameters, wherein each of the plurality of models comprises a different level of detail; and
display, at the client device, a model from the plurality of models based on a proximity of the asset from a viewpoint of a user in a virtual environment.

20. The non-transient computer-readable storage medium of claim 19, wherein the instructions being executable by the one or more processors cause the one or more processors to:
determine the proximity of the asset from the viewpoint of the user in the virtual environment; and
select at least one of the plurality of models based on the proximity.
